(19) United States
(12) Patent Application Publication
(10) Pub. No.: US 2024/0310924 A1
(43) Pub. Date: Sep. 19, 2024

(54) OPERATION RECEIVING DEVICE

(71) Applicant: KABUSHIKI KAISHA TOKAI RIKA DENKI SEISAKUSHO, Aichi (JP)

(72) Inventors: Taiyo UMEDA, Aichi (JP); Masaki HYODO, Aichi (JP)

(73) Assignee: KABUSHIKI KAISHA TOKAI RIKA DENKI SEISAKUSHO, Aichi (JP)

(21) Appl. No.: 18/566,253

(22) PCT Filed: May 27, 2022
(86) PCT No.: PCT/JP2022/021686

§ 371 Date: Dec. 1, 2023

(30) Foreign Application Priority Data
Jun. 9, 2021 (JP) 2021-096788

(51) Int. Cl. G06F 3/02; B60R 16/02; H01H 23/24

(52) U.S. Cl. CPC G06F 3/0202; B60R 16/02; H01H 23/24

(57) ABSTRACT

An operation receiving device includes an operation unit configured to detect a position of contact of a finger of a user on a first axis and a direction of an operation of the user with the finger. The direction is orthogonal to the first axis. The operation unit is provided to have different tilt angles in accordance with the directions of the operation. The operation unit includes two tact switches that are each pushed down at any of the different tilt angles. The operation unit detects the direction of the operation on the basis of the tact switches that are pushed down. At least a portion of an operation surface with which the finger of the user comes into contact on the operation unit has a rounded shape having a shorter height than thickness from a base of a nail of the finger to a ball of the finger.

### TECHNICAL FIELD

The present invention relates to an operation receiving device.

### BACKGROUND ART

In recent years, various devices for detecting input operations by users have been developed. For example, Patent Literature 1 discloses a toggle switch device that includes a plurality of knobs corresponding to a plurality of respective icons displayed on a display panel and brings the function corresponding to a knob operated by a user into operation.

### CITATION LIST

### Patent Literature

Patent Literature 1: JP 2019-75266A

### SUMMARY OF INVENTION

### Technical Problem

However, the toggle switch device disclosed in Patent Literature 1 can be high in manufacturing cost and request a complicated operation because the toggle switch device includes a plurality of knobs.

The present invention has been thus devised in view of the problem described above. An object of the present invention is to allow for an intuitive operation input in a simpler configuration.

### Solution to Problem

In order to solve the above problem, according to an aspect of the present invention, there is provided an operation receiving device including an operation unit configured to detect a position of contact of a finger of a user on a first axis and a direction of an operation of the user with the finger. The direction is orthogonal to the first axis. The operation unit is provided to have different tilt angles in accordance with the directions of the operation. The operation unit includes two tact switches that are each pushed down at any of the different tilt angles. The operation unit detects the direction of the operation on the basis of the tact switches that are pushed down. At least a portion of an operation surface with which the finger of the user comes into contact on the operation unit has a rounded shape and the rounded shape is formed to have shorter height from a lower end to an upper end of the rounded shape than thickness from a base of a nail of the finger of the user to a ball of the finger.

### Advantageous Effects of Invention

As described above, the present invention allows for an intuitive operation input in a simpler configuration.

### BRIEF DESCRIPTION OF DRAWINGS

FIG. 1 is a diagram for describing a configuration example of a comparative device 90 according to an embodiment of the present invention.

FIG. 2 is a diagram for describing a configuration example of an operation receiving device 10 according to the embodiment.

FIG. 3 is a diagram for describing the configuration example of the operation receiving device 10 according to the embodiment.

FIG. 4 is a diagram for describing a feature of a rounded shape of a comparative operation unit 810 according to the embodiment.

FIG. 5 is a diagram for describing a feature of a rounded shape of an operation unit 110 according to the embodiment.

FIG. 6 is a diagram for describing the feature of the rounded shape of the operation unit 110 according to the embodiment.

FIG. 7 is a diagram for describing disposition of the operation unit 110 based on a straight line EDL along an estimated approaching direction according to the embodiment.

FIG. 8 is a diagram for describing an example of the estimated approaching direction according to the embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

When there are provided knobs that correspond to displayed icons one by one as in the toggle switch device disclosed in Patent Literature 1, knobs have to be increased in number as more icons are displayed. This leads to an increase in manufacturing cost.

In addition, a large number of knobs can lead to a decrease in functionality such as disabling a user from intuitively selecting the knob corresponding to the icon for a target operation.

To solve the points as described above, a technique is also conceivable that, for example, provides only one knob for a plurality of icons and achieves the selection of an icon with an electrostatic sensor or the like included in the knob.

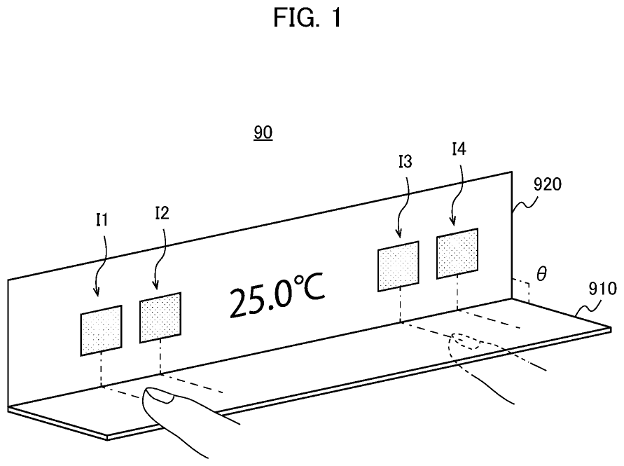

FIG. 1 is a diagram for describing a configuration example of a comparative device 90 according to an embodiment of the present invention.

The comparative device 90 illustrated in FIG. 1 includes an operation unit 910 and a display unit 920.

The operation unit 910 includes an electrostatic sensor for detecting a selection operation of a user on any of a plurality of icons displayed on the display unit 920 and a single toggle switch for detecting an input operation of the user on the selected icon.

The toggle switch described above is provided to be tiltable in two directions. The toggle switch is capable of detecting two different input operations in accordance with directions in which the toggle switch is tilted.

The two different input operations described above may be, for example, turning on and off a function, increasing and decreasing the execution level of the function, and the like.

It should be noted that examples of the execution level of the function described above include temperature that serves as a criterion for adjustment by an air conditioner, the sound volume of an audio device, and the like.

For example, a case is conceived where a user selects an icon I1 displayed on the display unit 920 and turns on the function corresponding to the icon I1.

In this case, the user touches the position corresponding to the icon I1 on the upper surface of the operation unit 910 with a finger as illustrated in FIG. 1 and pushes down the operation unit 910 in the down direction to tilt the operation unit 910 in the direction.

In contrast, when a user turns off the function corresponding to the icon I1, the user touches the position corresponding to the icon I1 on the lower surface of the operation unit 910 with a finger and pushes up the operation unit 910 in the up direction to tilt the operation unit 910 in the direction.

In addition, for example, a case is conceived where a user selects an icon I3 displayed on the display unit 920 and increases the execution level of the function corresponding to the icon I3.

In this case, the user touches the position corresponding to the icon I3 on the lower surface of the operation unit 910 with a finger as illustrated in FIG. 1 and pushes up the operation unit 910 in the up direction to tilt the operation unit 910 in the direction.

In contrast, when a user decreases the execution level of the function corresponding to the icon I3, the user touches the position corresponding to the icon I3 on the upper surface of the operation unit 910 with a finger and pushes down the operation unit 910 in the down direction to tilt the operation unit 910 in the direction.

The operation unit 910 detects the position of the contact of a finger as described above in an operation by a user and the direction of the operation on the toggle switch, and transmits pieces of information regarding the position of the contact and the direction of the operation to a control device that controls the function corresponding to the icon.

The configuration example of the comparative device 90 has been described above. The configuration as described above makes it possible to detect an operation corresponding to each of a plurality of icons with a single toggle switch and reduce the manufacturing cost.

The comparative device 90, however, requests the operation unit 910 to be pushed up from the down direction to the up direction as described above when an operation is performed for turning on or off a function or increasing or decreasing the function level.

To detect the pushing-up operation as described above, it is necessary to dispose an electrostatic sensor on the lower surface of the operation unit 910 in addition to the upper surface.

In addition, the pushing-up operation as described above requests the operation unit 910 to be interposed between an icon and a finger, different from an operation on the upper surface of the operation unit 910.

This causes a user to have difficulty in intuitively grasping the positional relationship between the icon and the finger and the user can select an icon different from the target icon.

Further, when the operation unit 910 and the display unit 920 are provided to cause an angle θ formed between the operation surface of the operation unit 910 and the display surface of the display unit 920 to be a right angle, operability can be further decreased depending on the positional relationship between the comparative device 90 and the user.

For example, a situation is conceived in which a user operates the comparative device 90 from a left front position as illustrated in FIG. 1.

Examples of the situation described above include a situation in which, when the comparative device 90 is disposed between the driver's seat and the passenger seat at the front of the compartment of a vehicle, a user sitting on the driver's seat or the passenger seat provided in the vehicle compartment on the left side operates the comparative device 90.

When the user intends to turn on the function corresponding to an icon I2 in this situation, the user is requested, for example, to touch the position corresponding to the icon I2 on the upper surface of the operation unit 910 and push down the operation unit 910 in the down direction.

However, in the situation in which the user operates the comparative device 90 from the left front position, the position on the operation unit 910 that appears to be below the icon I2 in the user's field of vision as illustrated in FIG. 1 may be the position corresponding to the icon I1 at some angles.

This can cause the user to turn on the function corresponding to the icon I1 by mistake when intending to turn on the function corresponding to the icon I2. In addition, similarly, the position on the operation unit 910 that appears to be below an icon I4 in the user's field of vision may be the position corresponding to the icon I3 at some angles.

This can cause the user to operate the execution level of the function corresponding to the icon I3 by mistake when intending to operate the execution level of the function corresponding to I4.

The erroneous recognition of the position as described above is likely to occur when the angle θ formed between the operation surface of the operation unit 910 and the display surface of the display unit 920 is a right angle or an acute angle, but less likely to occur as the operation surface and the display surface are flusher with each other.

The technical idea according to the present invention has been conceived in view of the point as described above, and achieves a more intuitive operation and prevents an operation mistake.

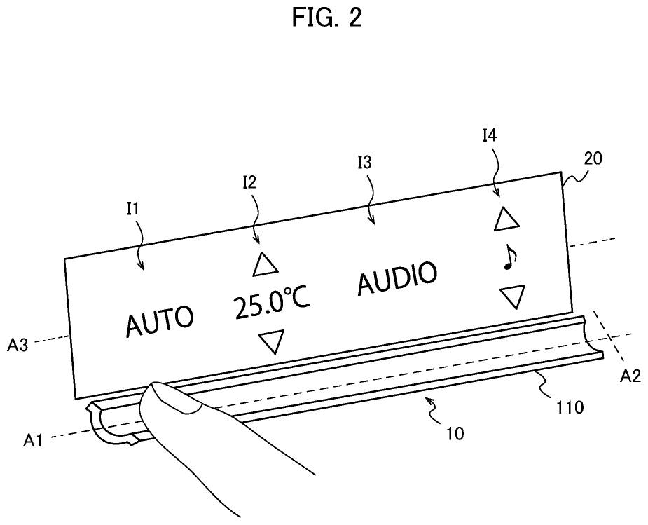

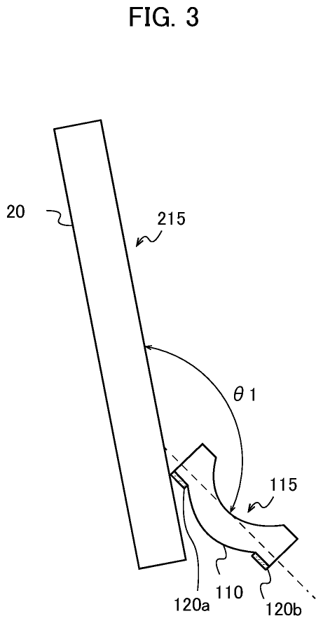

The following describes a configuration example of the operation receiving device 10 according to an embodiment of the present invention in detail with reference to FIGS. 2 and 3.

The operation receiving device 10 according to the present embodiment includes an operation unit 110 that detects the position of the contact of a finger of a user on a first axis A1 and the direction of an operation orthogonal to the first axis A1. As an example, the direction of an operation described above may be the direction of a slide operation away from or toward the user along a second axis A2 orthogonal to the first axis A1.

The upper surface (operation surface 115) of the operation unit 110 according to the present embodiment is provided with a component such as an electrostatic sensor for detecting the position of the contact of a finger.

In addition, at least a portion of the operation surface 115 of the operation unit 110 according to the present embodiment may have a rounded shape.

The shape as described above allows the operation surface 115 to fit the shape of the ball of a finger and makes it possible to increase usability for an operation and the precision of detecting the position of contact.

In addition, one of the features of the operation unit 110 according to the present embodiment is that the operation unit 110 is provided to have different tilt angles in accordance with the directions of an operation described above. The operation unit 110 may be provided to be tiltable, for example, in two directions along the second axis A2.

In the case of the example illustrated in FIG. 2, the operation unit 110 may be tiltable in both directions away from a user and toward the user along the second axis A2.

In addition, the operation unit 110 according to the present embodiment includes two tact switches 120a and 120b that are each pushed down at any of the different tilt angles described above. For example, the tact switches 120a and 120b may be each disposed in association with two directions along the second axis A2.

The operation unit 110 according to the present embodiment detects the direction of an operation described above on the basis of a tact switch 120 that is pushed down. In other words, the operation unit 110 is tilted in accordance with an operation of a user with a finger, thereby detecting, as the direction of the operation, the direction in which any of the tact switch 120a or 120b is pushed down.

The tact switch 120a or 120b may be disposed on the lower surface of the operation unit 110 to be pushed down when the operation unit 110 is tilted, for example, as illustrated in FIG. 3.

Meanwhile, the disposition illustrated in FIG. 3 is merely an example. It is sufficient if the tact switch 120a or 120b is disposed outside or inside the operation unit 110 to be pushed down when the operation unit 110 is tilted.

As described above, the operation unit 110 according to the present embodiment is capable of detecting the position of the contact of a finger on the first axis A1 and also detecting the tilt direction of the operation unit 110, that is, the direction of an operation with the finger by using the tact switches 120a and 120b.

The configuration as described above allows a user to constantly perform an operation on the upper surface (operation surface 115) of the operation unit 110 and eliminates the necessity to perform an operation such as pushing up the operation unit 110 from the down direction to the up direction, different from the comparative device 90.

This makes an operation simpler to increase operability and makes it possible to prevent an operation mistake that can be made when an operation is performed on the lower surface of the operation unit 110.

Further, the operation unit 110 according to the present embodiment is disposed to offer an obtuse angle as an angle θ1 formed between the operation surface 115 and a display surface 215 of a display device 20 as illustrated in FIG. 3.

The disposition as described above makes it easier to grasp the positional relationship between an icon displayed on the display device 20 and the operation surface 115 and makes it possible to effectively prevent a selection mistake as described by using the comparative device 90 even when the operation unit 110 is operated diagonally from the front direction.

Subsequently, an application example the operation receiving device 10 according to the present embodiment will be described.

As an example, the operation receiving device 10 according to the present embodiment may receive operations for functions of a plurality of respective devices included in a vehicle.

In the case of the example illustrated in FIG. 2, the operation receiving device 10 is fixedly disposed below the display device 20 that displays the plurality of icons I1 to I4 along a third axis corresponding to the first axis A1.

In this case, the operation unit 110 may be disposed to have the first axis A1 and the third axis A3 substantially in parallel.

The disposition as described above allows a user to intuitively select an icon I corresponding to a target function while sliding a finger on the operation surface 115.

It should be noted that the icon I1 to the icon I4 are icons for turning on/off the automatic setting of the air conditioner, the temperature serving as the criterion for adjustment by the air conditioner, turning on/off the audio device, and controlling the sound volume of the audio device, respectively, in the case of the example illustrated in FIG. 2.

For example, when a user wishes to turn on the automatic setting of the air conditioner, the user touches the position corresponding to the icon I1 on the operation surface 115 with a finger as illustrated in FIG. 2 to tilt the operation unit 110 away from the user.

The tact switch 120a is pushed down through the operation described above and the operation unit 110 detects the tilt direction of the operation unit 110, that is, the direction of the operation.

The operation unit 110 transmits pieces of information regarding the detected position of the contact of the finger and the direction of the operation described above to the control device that is communicably connected.

The control device identifies the target function as turning on/off the automatic setting of the air conditioner on the basis of the received information regarding the position of the contact and pieces of information regarding the icons I1 to 14 displayed on the display device 20.

In addition, the control device identifies the contents of the control as turning on the automatic setting of the air conditioner on the basis of the received information regarding the direction of the operation and predefined setting, and executes the control.

In addition, for example, when a user wishes to turn down the sound volume of the audio device, the user touches the position corresponding to the icon I4 on the operation surface 115 with a finger to tilt the operation unit 110 toward the user.

The tact switch 120b is pushed down through the operation described above and the operation unit 110 detects the tilt direction of the operation unit 110, that is, the direction of the operation.

The operation unit 110 transmits pieces of information regarding the detected position of the contact of the finger and the direction of the operation described above to the control device.

The control device identifies the target function as changing the sound volume of the audio device on the basis of the received information regarding the position of the contact and the pieces of information regarding the icons I1 to I4 displayed on the display device 20.

In addition, the control device identifies the contents of the control as turning down the sound volume of the audio device on the basis of the received information regarding the direction of the operation and the predefined setting, and executes the control.

The application example has been described above in which the operation receiving device 10 according to the present embodiment is provided in the compartment of a vehicle.

It should be noted that the operation unit 110 according to the present embodiment may detect the number of fingers in contact and transmit the detected number of fingers to the control device.

For example, when a user touches the operation surface 115 with two fingers to perform a slide operation, the operation unit 110 transmits information regarding the slide operation to the control device.

The control device may cause the display device 20 to display other icons I5 to I8 corresponding to functions different from those of the respective icons I1 to I4 instead of the icons I1 to I4 on the basis of the received information regarding the slide operation described above.

The processing described above makes it possible to receive operation inputs for a plurality of functions without being limited by the size of the display surface 215 of the display device 20.

Next, a feature related to the shape of the operation surface 115 according to the present embodiment will be described in detail.

As described above, at least a portion of the operation surface 115 of the operation unit 110 according to the present embodiment has a rounded shape.

The operation surface 115 has a rounded shape. This causes the operation surface 115 to fit the ball of a finger during an operation. It is possible to increase usability for the operation and the precision of detecting the position of the contact.

Meanwhile, the rounded shape as described above is requested to be precisely designed in accordance with the shape of a finger used for an operation.

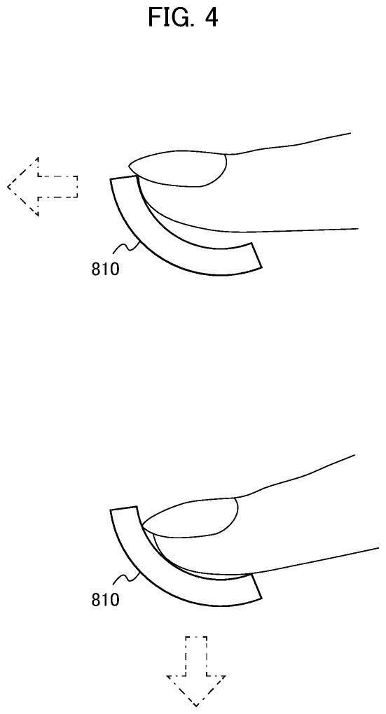

FIG. 4 is a diagram for describing a feature of the rounded shape of a comparative operation unit 810 according to the present embodiment.

The comparative operation unit 810 has a rounded shape that is big enough for the ball of a finger as illustrated in FIG. 4.

When the rounded shape has the feature as described above, a nail of a user tilting the comparative operation unit 810 away from the user hits against the upper end of the operation surface as illustrated in the upper part of FIG. 4 in some cases. This can cause the user to feel uncomfortable.

In addition, when the rounded shape has the feature as described above, a nail of a user tilting the comparative operation unit 810 toward the user (down) hits against the middle of the operation surface as illustrated in the lower part of FIG. 4 in some cases. This can cause the user to feel uncomfortable.

The operation unit 110 according to the present embodiment has been devised in view of the points as described above. The operation unit 110 eliminates uncomfortability caused by a hit of a nail during an operation.

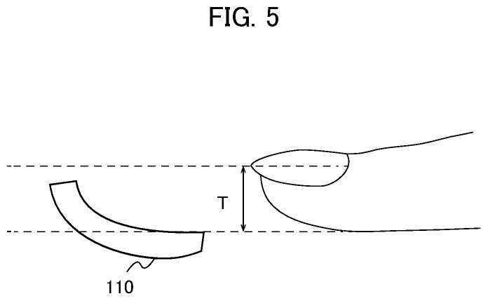

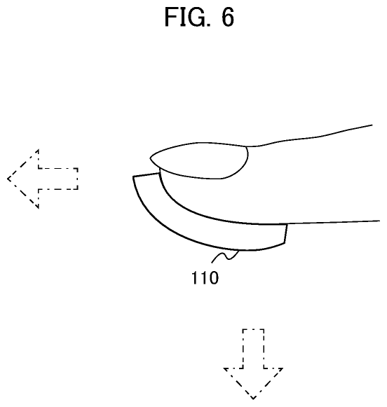

Each of FIGS. 5 and 6 is a diagram for describing a feature of the rounded shape of the operation unit 110 according to the present embodiment.

As illustrated in FIG. 5, one of the features of the rounded shape of the operation unit 110 according to the present embodiment is that the rounded shape is formed to have the shorter height from the lower end to the upper end than thickness T from the base of the nail of a finger of a user to the ball of the finger.

It should be noted that the thickness T from the base of the nail to the ball of the finger may be defined, for example, on the basis of an index finger that is more likely to be used for an operation. Alternatively, the thickness T may be defined on the basis of the average or the like of an index finger, a middle finger, a ring finger, and a little finger.

The feature of the rounded shape as described above prevents a nail from hitting against the operation surface both when a user tilts the operation unit 110 away from the user and when a user tilts the operation unit 110 toward the user (down) as illustrated in FIG. 6. This makes it possible to eliminate uncomfortability caused by the hit of the nail.

Further, it is possible to prevent the hit of the nail from causing space between the operation surface and the ball of the finger and increase the degree of fit and the precision of detecting the position of the contact during an operation.

In addition, the operation unit 110 according to the present embodiment may be disposed on the basis of a straight line EDL along an estimated approaching direction that is highly likely to be a direction in which a finger of a user approaches the operation surface 115.

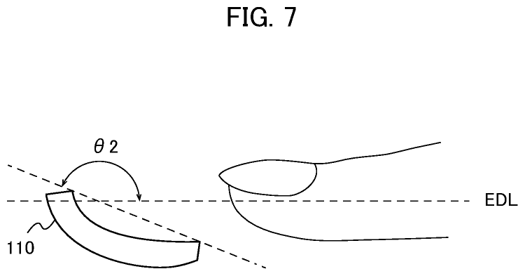

FIG. 7 is a diagram for describing the disposition of the operation unit 110 based on the straight line EDL along the estimated approaching direction according to the present embodiment.

It should be noted that the example illustrated in FIG. 7 assumes that a finger of a user approaches the operation surface 115 from the right side of the diagram.

One of the features of the operation unit according to the present embodiment is that the operation unit is disposed to offer an obtuse angle as an angle θ2 formed to correspond to the ball side and the back side of a finger of a user during an operation among angles formed between the straight line connecting the upper end and the lower end of a rounded shape and the straight line EDL along the estimated approaching direction as illustrated in FIG. 7.

The disposition feature as described above prevents the operation surface from being positioned on an extension of the nail of a finger of a user when the finger of the user approaches the operation surface 115 and thus makes it possible to further reduce the possibility that the nail hits against the operation surface 115.

It should be noted that the estimated approaching direction according to the present embodiment may be defined by using, as starting point, the position of another component on which a hand or an arm of a user is placed.

The following assumes that the operation receiving device 10 according to the present embodiment is disposed in the compartment of a vehicle.

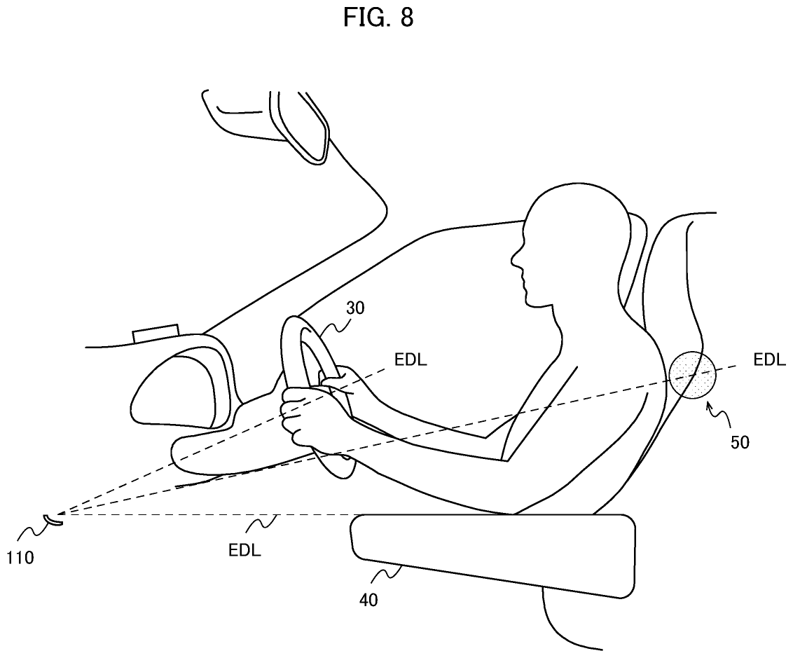

FIG. 8 is a diagram for describing an example of the estimated approaching direction according to the present embodiment.

It should be noted that the operation receiving device 10 is disposed on an instrument panel at the front of the vehicle compartment in FIG. 8.

In this case, a hand of a user driving the vehicle is considered to be positioned on a steering wheel 30 or an arm rest 40 in many cases.

For example, the estimated approaching direction may be therefore a direction toward the position at which the operation unit 110 is disposed with the steering wheel 30 as a starting point. The steering wheel 30 is provided in the compartment of the vehicle.

In addition, for example, the estimated approaching direction may be a direction toward the position at which the operation unit 110 is disposed with the arm rest 40 as a starting point. The arm rest 40 is provided in the compartment of the vehicle.

In addition, for example, the estimated approaching direction may be a direction toward the position at which the operation unit 110 is disposed with a seat shoulder section 50 as a starting point. The seat shoulder section 50 is a portion of a seat provided in the compartment of a vehicle that comes into contact with a user around a shoulder.

As described above, the estimated approaching direction is defined by taking into consideration the basic position of a hand of a user who is not operating the operation unit 110. This makes it possible to further increase the above-described effect of preventing a hit of a nail.

### 2. Supplemental Information

Heretofore, preferred embodiments of the present invention have been described in detail with reference to the appended drawings, but the present invention is not limited thereto. It is apparent that those skilled in the art of the present invention would have conceived of various modified examples or corrected examples within the scope of the technical ideas described in the claims and it should be appreciated that they naturally belong to the technical scope of the present invention.

### REFERENCE SIGNS LIST

10 operation receiving device
110 operation unit
115 operation surface
120 tact switch
20 display device
215 display surface
30 steering wheel
40 arm rest
50 seat shoulder section
A1 first axis
A2 second axis
A3 third axis

1. An operation receiving device comprising
an operation unit configured to detect a position of contact of a finger of a user on a first axis and a direction of an operation of the user with the finger, the direction being orthogonal to the first axis, wherein
the operation unit is provided to have different tilt angles in accordance with the directions of the operation,
the operation unit includes two tact switches that are each pushed down at any of the different tilt angles,
the operation unit detects the direction of the operation on a basis of the tact switches that are pushed down, and
at least a portion of an operation surface with which the finger of the user comes into contact on the operation unit has a rounded shape and the rounded shape is formed to have shorter height from a lower end to an upper end of the rounded shape than thickness from a base of a nail of the finger of the user to a ball of the finger.

2. The operation receiving device according to claim 1, wherein the operation unit is disposed to offer an obtuse angle as an angle formed to correspond to a ball side and a back side of the finger of the user during an operation among angles formed between a straight line connecting the upper end and the lower end of the rounded shape and a straight line along an estimated approaching direction, the estimated approaching direction being highly likely to be a direction in which the finger of the user approaches the operation surface.

3. The operation receiving device according to claim 2, wherein the operation receiving device is disposed in a compartment of a vehicle.

4. The operation receiving device according to claim 3, wherein the estimated approaching direction includes a direction in which the operation surface is disposed with a steering wheel as a starting point, the steering wheel being provided in the compartment of the vehicle.

5. The operation receiving device according to claim 3, wherein the estimated approaching direction includes a direction in which the operation surface is disposed with an arm rest as a starting point, the arm rest being provided in the compartment of the vehicle.
